(19) United States
(12) Patent Application Publication
(10) Pub. No.: US 2025/0010899 A1
(43) Pub. Date: Jan. 9, 2025

(54) TROLLEY AND FOLDING METHOD THEREOF

(71) Applicant: UNIQUE PRODUCT & DESIGN CO., LTD., Tainan City (TW)

(72) Inventor: Chih-Ching CHENG, Tainan City (TW)

(21) Appl. No.: 18/763,603

(22) Filed: Jul. 3, 2024

(30) Foreign Application Priority Data
Jul. 4, 2023 (TW) 112124990

(51) Int. Cl. B62B 3/02; B62B 5/06

(52) U.S. Cl. CPC B62B 3/022; B62B 5/067

(57) ABSTRACT

A trolley and a folding method thereof. The trolley includes a main bracket, a connecting mechanism, an upper bracket, a sliding mechanism, first to fourth connecting rods and a rear wheel. The main bracket has first and second ends. The upper bracket is connected to the first end through the connecting mechanism slidably arranged on the main bracket. Both ends of the first connecting rod are respectively connected to the sliding mechanism and the upper bracket. The second and third connecting rods are parallel to each other and connected to the sliding mechanism and the rear wheel. The fourth connecting rod has third and fourth ends and a bending portion. The third end is connected to the second connecting rod and located between the sliding mechanism and the rear wheel. The fourth end is connected to the connecting mechanism, at a middle section of which the bending portion is arranged.

### CROSS REFERENCE TO RELATED APPLICATIONS

This Non-provisional application claims priority under 35 U.S.C. § 119 (a) on Patent Application No(s). 112124990 filed in Taiwan, Republic of China on Jul. 4, 2023, the entire contents of which are hereby incorporated by reference.

### BACKGROUND

### Technology Field

The present disclosure relates to a trolley and, in particular, to a trolley having a compact size to decrease the amount of packaging volume.

### Description of Related Art

Small wheeled carts or trolleys, such as golf carts, strollers, shopping carts, camping trolleys, or other types of carts or trolleys, can provide considerable convenience for people's travel, daily leisure, shopping, or entertainment applications. If the cart or trolley is foldable, it can be folded up when not in use for easy carrying or storage.

However, although the conventional trolleys can provide people with some convenience, the folding process thereof is quite complicated, and the folded trolleys also occupy too much space, which increases the amount of packaging volume and is inconvenient for carrying or storage.

Therefore, it is desired to provide a trolley and a folding method thereof that can simplify the folding process, and reduce the size thereof in the folded state so as to decrease the amount of packaging volume.

### SUMMARY

In view of the foregoing, an objective of this disclosure is to provide a trolley and a folding method thereof that can simplify the folding process, and reduce the size thereof in the folded state so as to decrease the amount of packaging volume.

To achieve the above, a trolley of this disclosure includes a main bracket, a connecting mechanism, an upper bracket, a sliding mechanism, at least one first connecting rod, at least one second connecting rod, at least one third connecting rod, at least one rear wheel, and at least one fourth connecting rod. The main bracket has a first end and a second end. The connecting mechanism is arranged at the first end of the main bracket. The upper bracket is connected to the first end of the main bracket through the connecting mechanism. The sliding mechanism is slidably arranged on the main bracket. Two ends of the first connecting rod are respectively connected to the sliding mechanism and the upper bracket. The second connecting rod is disposed parallel to the third connecting rod. One end of the second connecting rod and one end of the third connecting rod are respectively connected to the sliding mechanism, and the other end of the second connecting rod and the other end of the third connecting rod are respectively connected to the rear wheel. The fourth connecting rod has a third end, a fourth end and a bending portion. The third end of the fourth connecting rod is connected to the second connecting rod and is located between the sliding mechanism and the rear wheel, and the fourth end of the fourth connecting rod is connected to the connecting mechanism. The bending portion is arranged at a middle section of the fourth connecting rod.

To achieve the above, this disclosure also provides a folding method of a trolley. The trolley includes a main bracket, a connecting mechanism, an upper bracket, a sliding mechanism, at least one first connecting rod, at least one second connecting rod, at least one third connecting rod, at least one rear wheel, at least one fourth connecting rod, a handlebar bracket, and a lower supporting frame. The main bracket has a first end and a second end. The connecting mechanism is arranged at the first end of the main bracket. The upper bracket is connected to the first end of the main bracket through the connecting mechanism. The sliding mechanism is slidably arranged on the main bracket. Two ends of the first connecting rod are respectively connected to the sliding mechanism and the upper bracket. The second connecting rod is disposed parallel to the third connecting rod. One end of the second connecting rod and one end of the third connecting rod are respectively connected to the sliding mechanism, and the other end of the second connecting rod and the other end of the third connecting rod are respectively connected to the rear wheel. The fourth connecting rod has a third end, a fourth end and a bending portion. The third end of the fourth connecting rod is connected to the second connecting rod and is located between the sliding mechanism and the rear wheel, and the fourth end of the fourth connecting rod is connected to the connecting mechanism. The bending portion is arranged at a middle section of the fourth connecting rod. The handlebar bracket is connected to one end of the upper bracket away from the main bracket. The lower supporting frame is arranged at the second end of the main bracket. The folding method includes the following steps of: releasing the handlebar bracket and folding the handlebar bracket relative to the upper bracket along a first direction, so that the handlebar bracket is located at one side of the main bracket; folding the upper bracket relative to the main bracket along a second direction, so that the first connecting rod carries to the sliding mechanism to slide on the main bracket, and then the second connecting rod, the third connecting rod and the fourth connecting rod carries the rear wheel to move toward the connecting mechanism; and continuously folding the upper bracket relative to the main bracket along the second direction until the lower supporting frame is fixed to the upper bracket.

In one embodiment, the second connecting rod includes a protruding portion, and the third end of the fourth connecting rod is connected to the protruding portion of the second connecting rod.

In one embodiment, the trolley further includes an elastic mechanism arranged inside the main bracket and connected to the sliding mechanism.

In one embodiment, the elastic mechanism includes at least one elastic member, the elastic member has an extension portion, and the extension portion is connected to the sliding mechanism.

In one embodiment, when the sliding mechanism slides on the main bracket, the extension portion moves along with the sliding mechanism.

In one embodiment, the second connecting rod has a notch, and a distance between the notch and the sliding mechanism is less than a distance between the notch and the rear wheel.

In one embodiment, a distance between the bending portion and the fourth end is less than a distance between the bending portion and the third end.

In one embodiment, the trolley further includes a front wheel arranged at the second end of the main bracket. When the trolley is in a folded state, the front wheel and the rear wheel face toward one direction, and the direction is parallel to an extending direction of the main bracket.

In one embodiment, when the trolley is in the folded state, the main bracket is parallel to the second connecting rod.

In one embodiment, when the trolley is in the folded state, an overall width of the trolley is less than or equal to 3.5 times of a width of the front wheel or the rear wheel.

In one embodiment, the trolley further includes a handlebar bracket, an upper supporting frame and a lower supporting frame. The handlebar bracket is connected to one end of the upper bracket away from the main bracket. The upper supporting frame is arranged at one side of the upper bracket away from the main bracket, and the lower supporting frame is arranged at the second end of the main bracket.

In one embodiment, when the trolley is in the folded state, the upper supporting frame is located at two sides of the front wheel, and the lower supporting frame is fixed on the upper bracket.

As mentioned above, in the trolley and the folding method thereof of this disclosure, the sliding mechanism is slidably arranged on the main bracket, two ends of the first connecting rod are respectively connected to the sliding mechanism and the upper bracket, the second connecting rod is disposed parallel to the third connecting rod, one end of the second connecting rod and one end of the third connecting rod are respectively connected to the sliding mechanism, the other end of the second connecting rod and the other end of the third connecting rod are respectively connected to the rear wheel, the third end of the fourth connecting rod is connected to the second connecting rod and is located between the sliding mechanism and the rear wheel, and the fourth end of the fourth connecting rod is connected to the connecting mechanism. Based on the structural design of this disclosure, when the sliding mechanism slides on the main bracket so as to carry the second connecting rod, the third connecting rod and the fourth connecting rod to move the rear wheel toward the connecting mechanism, there will be no structural interference between the fourth connecting rod and the connecting mechanism. In addition, when the trolley is in the folded state, the rear wheel can be moved toward and close to the first end of the main bracket. Accordingly, the trolley of this disclosure can simplify the folding process thereof, and reduce the size thereof in the folded state so as to decrease the amount of packaging volume.

### BRIEF DESCRIPTION OF THE DRAWINGS

The disclosure will become more fully understood from the detailed description and accompanying drawings, which are given for illustration only, and thus are not limitative of the present disclosure, and wherein:

FIGS. 1A to 1D are schematic diagrams showing a trolley according to an embodiment of this disclosure from different viewing angles;

FIGS. 2A to 2F are schematic diagrams showing the folding process of the trolley of FIG. 1A; and

FIG. 3 is a schematic diagram showing the trolley of FIG. 2E from another viewing angle.

### DETAILED DESCRIPTION OF THE DISCLOSURE

The present disclosure will be apparent from the following detailed description, which proceeds with reference to the accompanying drawings, wherein the same references relate to the same elements. The components appearing in the drawings of the following embodiments are only used to illustrate their relative relationships and do not represent the proportions or sizes of the actual components.

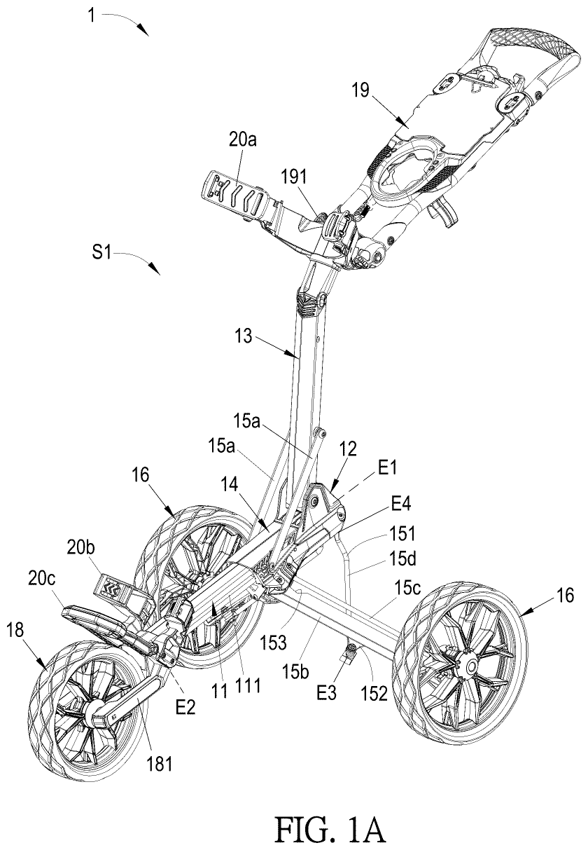

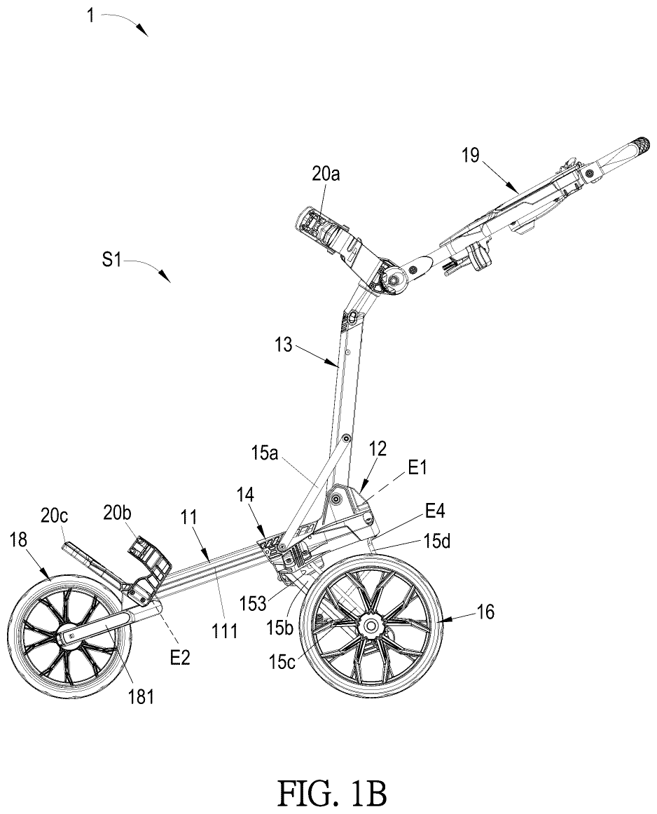

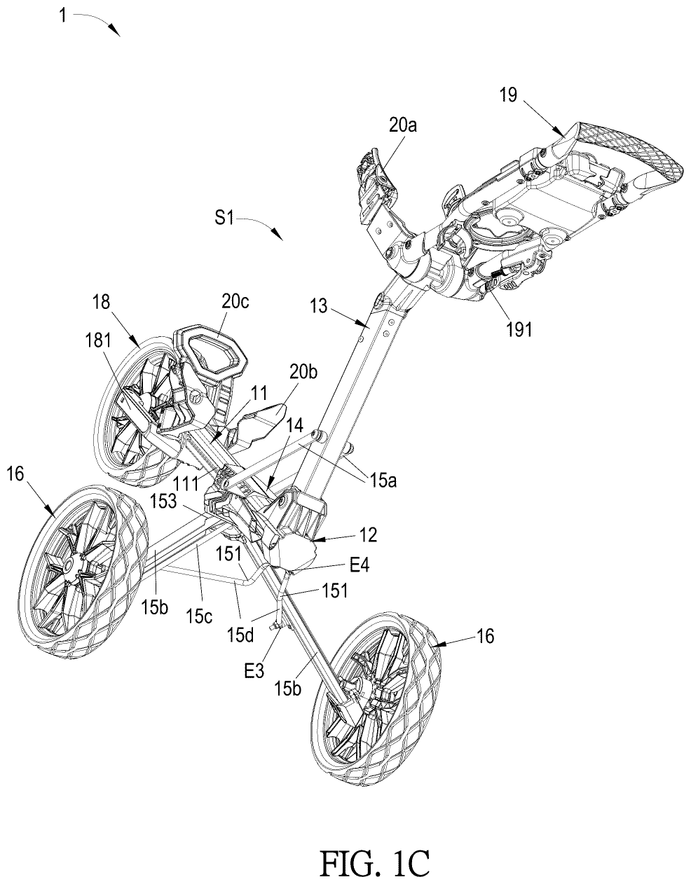

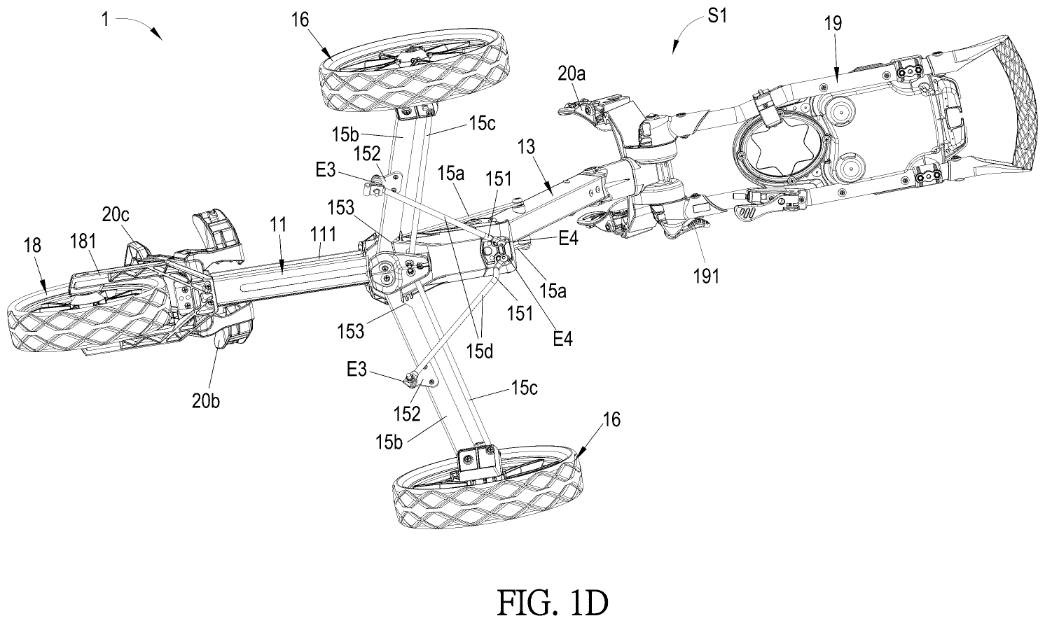

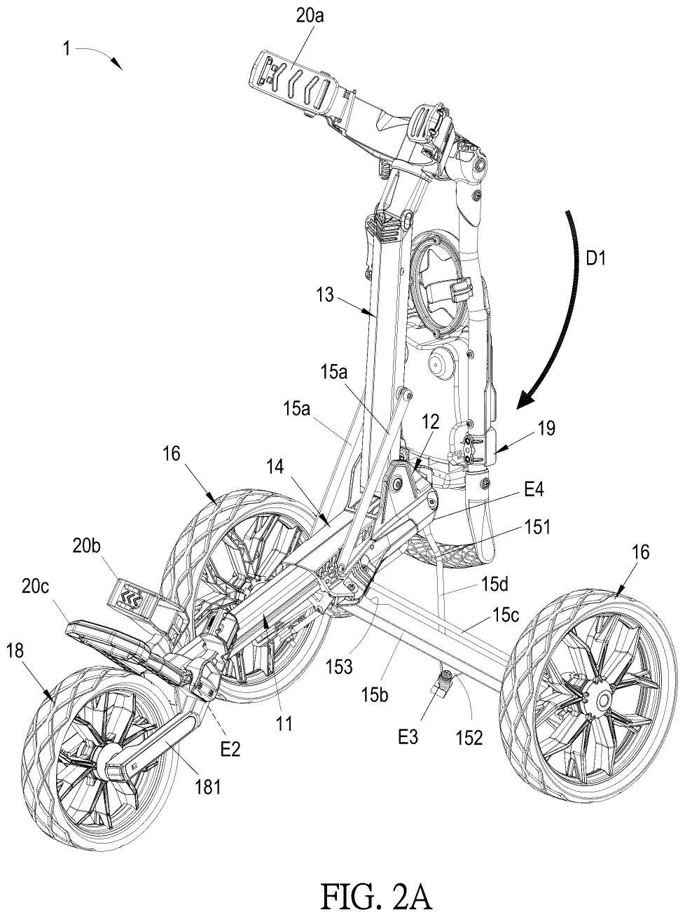

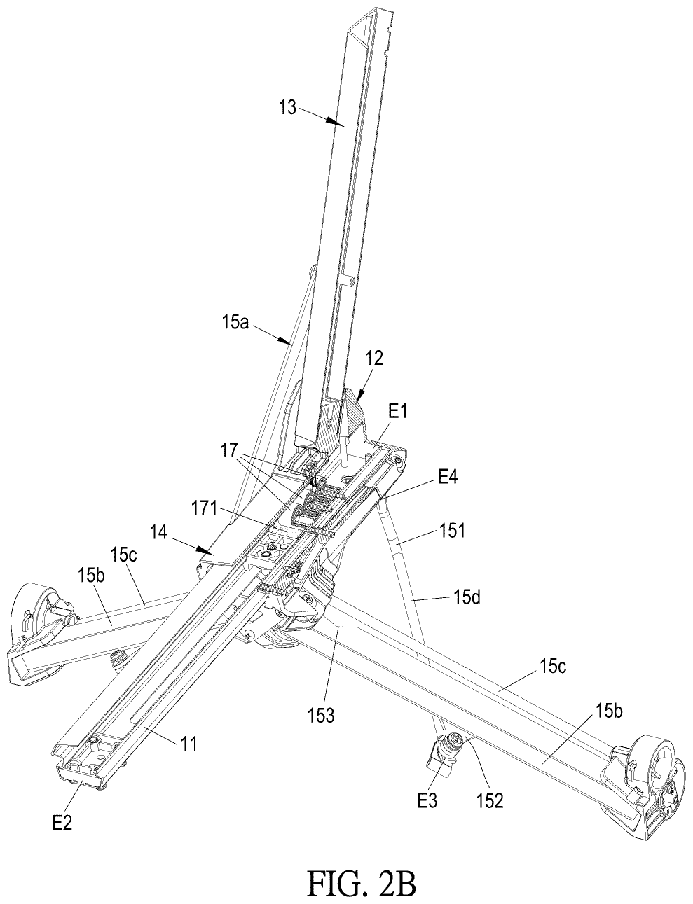

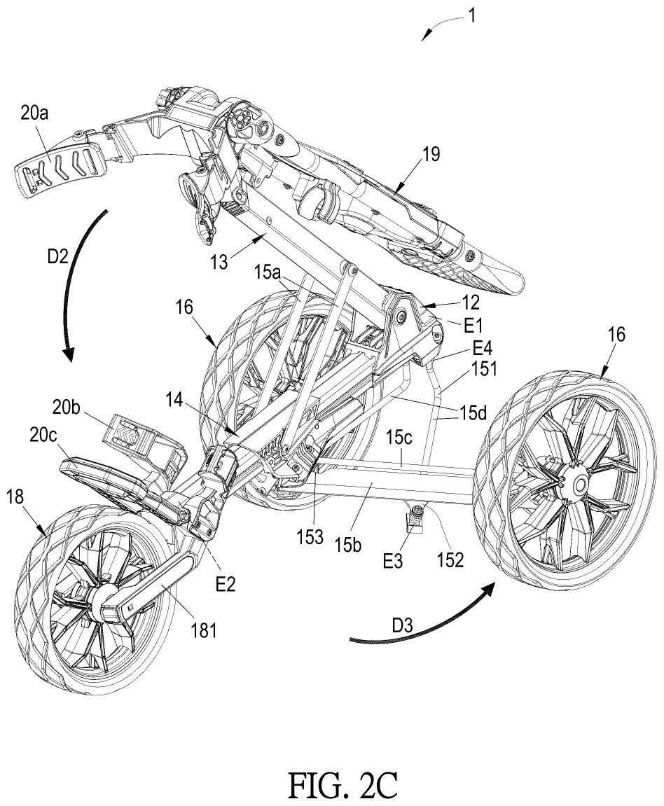

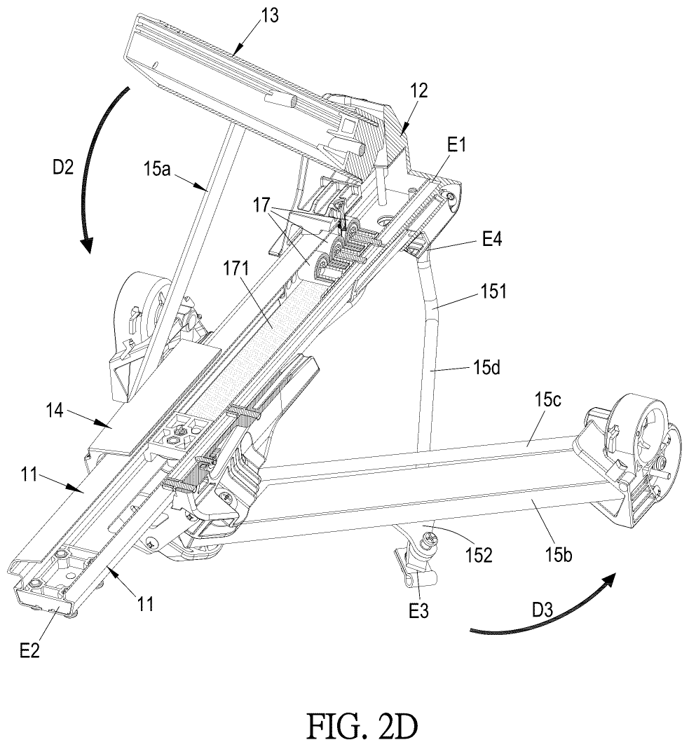

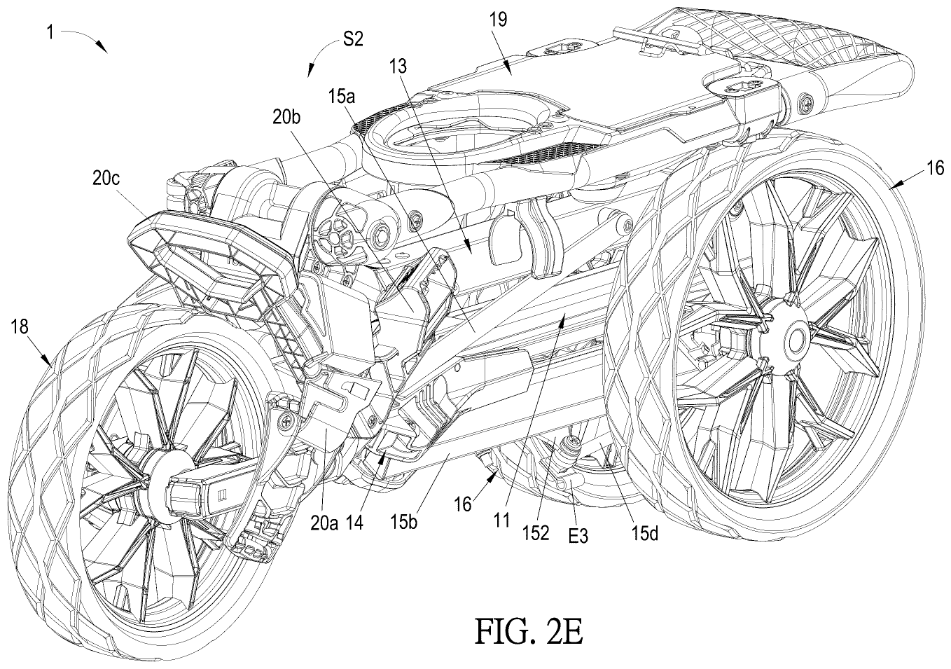

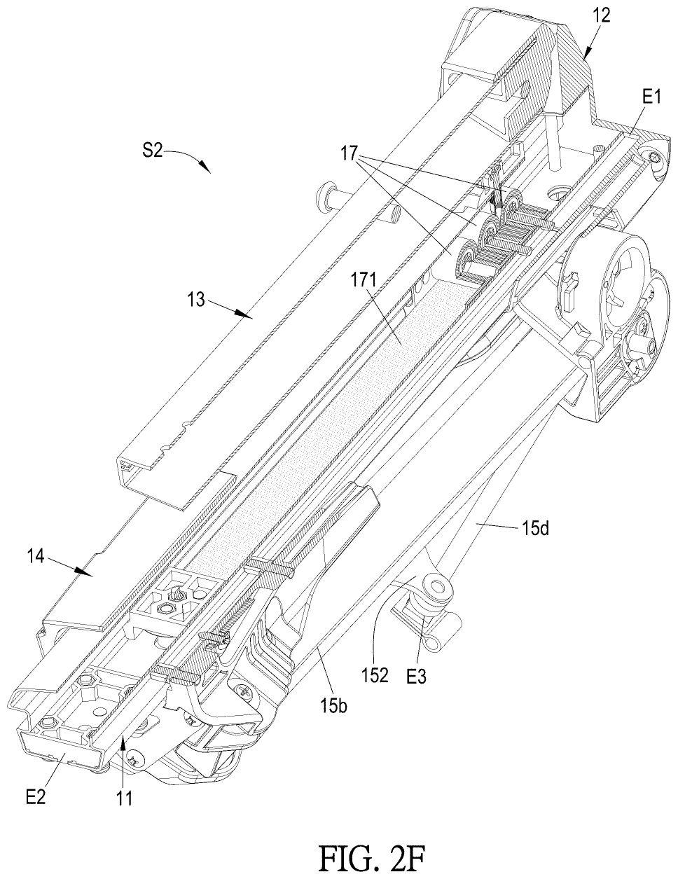

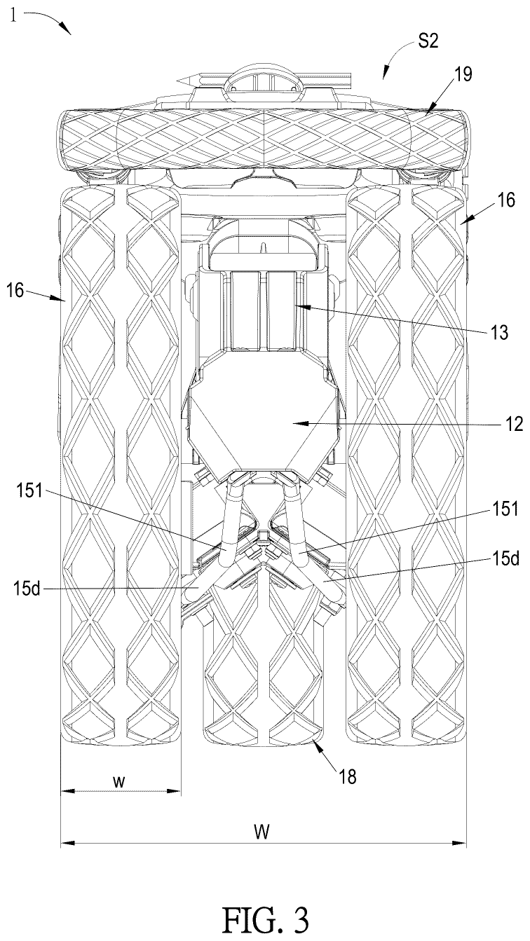

FIGS. 1A to 1D are schematic diagrams showing a trolley according to an embodiment of this disclosure from different viewing angles, FIGS. 2A to 2F are schematic diagrams showing the folding process of the trolley of FIG. 1A, and FIG. 3 is a schematic diagram showing the trolley of FIG. 2E from another viewing angle. To be noted, FIG. 2B only shows a partial sectional view of the trolley shown in FIG. 2A, FIG. 2D only shows a partial sectional view of the trolley shown in FIG. 2C, and FIG. 2F only shows a partial sectional view of the trolley shown in FIG. 2E. In addition, the trolley 1 shown in FIGS. 1A to 1D is in the operation state (unfolded state) S1, and the trolley 1 shown in FIGS. 2E and 3 is in the folded state S2. In the following embodiments, “connection” includes “relatively movable connection” and “relatively immovable connection”. “Relatively movable connection” can be, for example, a pivotal connection, which means that one object is fixed but another object can rotate relative to the previous object. “Relatively immovable connection” can be, for example, a fixed connection, which means that two objects cannot move relative to each other.

The trolley of this disclosure is a foldable trolley or cart with wheels, such as, for example but not limited to, a golf cart, a stroller, a shopping cart, or any of other foldable trolley or cart with wheels. The trolley 1 of this embodiment is, for example, a golf trolley. The detailed structure of the trolley 1 of this embodiment will be described below, and the folding and unfolding processes thereof will be described later.

Referring to FIGS. 1A to 1D, the trolley 1 includes a main bracket 11, a connecting mechanism 12, an upper bracket 13, a sliding mechanism 14, at least one first connecting rod 15a, at least one second connecting rod 15b, at least one third connecting rod 15c, at least one rear wheel 16, and at least one fourth connecting rod 15d. In this embodiment, the trolley 1 includes two first connecting rods 15a, two second connecting rods 15b, two third connecting rods 15c, two fourth connecting rods 15d, and two rear wheels 16. In addition, the trolley 1 further includes an elastic mechanism, a front wheel 18, a handlebar bracket 19, an upper supporting frame 20a and a lower supporting frame 20b.

The main bracket 11 has a first end E1 and a second end E2, and the connecting mechanism 12 is arranged at the first end E1 of the main bracket 11. In this embodiment, the connecting mechanism 12 is configured to connect the first end E1 of the main bracket 11 to another component, and the connecting mechanism 12 is connected to the first end E1 of the main bracket 11 by, for example, screwing, wedging, engaging or embedding.

The upper bracket 13 is connected to the first end E1 of the main bracket 11 through the connecting mechanism 12. In this embodiment, the upper bracket 13 is pivotally connected to the main bracket 11 through the connecting mechanism 12, so that the upper bracket 13 can, through the connecting mechanism 12, be relatively folded with respect to the main bracket 11.

The sliding mechanism 14, such as including a sliding bulk, is slidably arranged on the main bracket 11. To be understood, the main bracket 11 may include a slide rail 11 corresponding to the sliding mechanism 14, so that the sliding mechanism 14 can slide on the main bracket 11.

Two ends of the first connecting rod 15a are respectively connected to the sliding mechanism 14 and the upper bracket 13. In this embodiment, two ends of each of the two first connecting rods 15a can be respectively connected to the sliding mechanism 14 and the upper bracket 13 by screwing. Accordingly, when the sliding mechanism 14 slides on the main bracket 11, the first connecting rods 15a can be moved to carry the upper bracket 13 to fold with respect to the main bracket 11.

The second connecting rod 15b is disposed parallel to the third connecting rod 15c. Herein, one end of the second connecting rod 15b and one end of the third connecting rod 15c are respectively connected to the sliding mechanism 14, and the other end of the second connecting rod 15b and the other end of the third connecting rod 15c are respectively connected to the rear wheel 16. In this embodiment, one end of each second connecting rod 15b is connected to the sliding mechanism 14, and the other end of each second connecting rod 15b is connected to the rear wheel 16. Similarly, one end of each third connecting rod 15c is connected to the sliding mechanism 14, and the other end of each third connecting rod 15c is connected to the rear wheel 16. Specifically, the second connecting rod 15b, the third connecting rod 15c, an internal connection structure of the sliding mechanism 14 (for connecting the second connecting rod 15b and the third connecting rod 15c), and an internal connection structure of the rear wheel 16 (for connecting the second connecting rod 15b and the third connecting rod 15c) can together form a parallel four-bar linkage structure. Therefore, when the sliding mechanism 14 slides on the main bracket 11, the two second connecting rods 15b and the two third connecting rods 15c can simultaneously carry the two rear wheels 16 to move relative to the main bracket 11, and simultaneously make the two rear wheels 16 move toward the first end E1 of the upper bracket 13 and close to the upper bracket 13. In addition, each second connecting rod 15b in this embodiment has a notch 153, and the notch 153 is adjacent to the connection of the corresponding third connecting rod 15c and the sliding mechanism 14. Particularly, the distance between the notch 153 and the sliding mechanism 14 is less than the distance between the notch 153 and the rear wheel 16. The notch 153 can be used to allow each second connecting rod 15b to avoid the connection of the corresponding third connecting rod 15c and the sliding mechanism 14 during the folding process, thereby avoiding the structural interference between the second connecting rod 15b and the connection of the third connecting rod 15c and the sliding mechanism 14.

The fourth connecting rod 15d has a third end E3, a fourth end E4 and a bending portion 151. The third end E3 of the fourth connecting rod 15d is connected to the second connecting rod 15b and is located between the sliding mechanism 14 and the rear wheel 16, and the fourth end E4 of the fourth connecting rod 15d is connected to the connecting mechanism 12. The bending portion 151 is arranged at a middle section of the fourth connecting rod 15d. To be understood, “the bending portion 151 is arranged at a middle section of the fourth connecting rod 15d” indicates that the bending portion 151 is not directly connected to the third end E3 or the fourth end E4, but in the middle section of the fourth connecting rod 15d between the third end E3 and the fourth end E4. In this embodiment, the distance between the bending portion 151 and the fourth end E4 is less than the distance between the bending portion 151 and the third end E3. In addition, each second connecting rod 15b includes a protruding portion 152, and the third end E3 of each fourth connecting rod 15d is connected to the protruding portion 152 of the corresponding second connecting rod 15b. In this embodiment, the protruding portion 152 is connected to the main body of the second connecting rod 15b by, for example, screwing, but this disclosure is not limited thereto. In different embodiments, the protruding portion 152 and the main body of the second connecting rod 15b can be integrally formed as one piece. To be noted, in the trolley 1 of this embodiment, the two first connecting rods 15a, the two second connecting rods 15b, the two third connecting rods 15c, the two fourth connecting rods 15d and the two rear wheels 16 can be symmetrically arranged at two sides of the main bracket 11.

The front wheel 18 is arranged at the second end E2 of the main bracket 11. In this embodiment, the front wheel 18 is connected to the second end E2 of the main bracket 11 through the front wheel bracket 181. In addition, the handlebar bracket 19 is connected to one end of the upper bracket 13 away from the main bracket 11. In this embodiment, the trolley 1 may further include an adjusting member 191, which is provided at the connection of the handlebar bracket 19 and the upper bracket 13. Accordingly, the folding process of the handlebar bracket 19 and the main bracket 11 can be controlled through the adjusting member 191. In some embodiments, the adjusting member 191 may include a handle, a spring, and a convex-concave structure (not shown). By loosening the adjusting member 191, the handlebar bracket 19 can be folded relative to the upper bracket 13. When the adjusting member 191 is fastened, the relative position of the handlebar bracket 19 and the main bracket 11 can be fixed.

The upper supporting frame 20a is arranged at one side of the upper bracket 13 away from the main bracket 11. In this case, the upper supporting frame 20a is adjacent to the connection of the upper bracket 13 and the handlebar bracket 19. The lower supporting frame 20b is arranged at the second end E2 of the main bracket 11. In addition, in order to fix the object(s) (e.g. a golf bag) placed on the trolley 1 so as to avoid the falling of the object when the trolley 1 moves, the trolley 1 of this embodiment may further include a supporting base 20c, which can be arranged at the second end E2 of the main bracket 11. Therefore, when placing an object on the trolley 1, the supporting base 20c can be used to support the object, and the upper supporting frame 20a and the lower supporting frame 20b can be used to fix the upper and lower sides of the object so as to prevent it from falling during moving. In some embodiments, the expansion width of the upper supporting frame 20a and/or the lower supporting frame 20b can be adjusted to be suitable for fixing objects of different widths.

In addition, referring to FIGS. 2B and 2D, the elastic mechanism is arranged inside the main bracket 11, and the elastic mechanism is connected to the sliding mechanism 14. In this embodiment, the elastic mechanism includes at least one elastic member 17. The elastic member 17 has an extension portion 171, which is connected to the sliding mechanism 14. Therefore, when the sliding mechanism 14 slides on the main bracket 11, the extension portion 171 simultaneously extends from the elastic member 17 and moves with the sliding mechanism 14. The elastic member 17 of this embodiment is, for example but not limited to, a coil spring. When the extension portion 171 of the coil spring (elastic member 17) is driven by the sliding mechanism 14 and extends from the coil spring, the coil spring (elastic member 17) will generate an elastic restoring force, which can provide an automatic restoring force when the user performing the unfolding process of the trolley 1. Here, three elastic members 17 (coil springs) are arranged side by side, the three extension portions 171 of the three elastic members 17 (coil springs) are overlapped, and the three extension portions 171 are all connected to the sliding mechanism 14. Accordingly, when the sliding mechanism 14 slides on the main bracket 11, it can simultaneously drive the extension portions 171 of the three elastic members 17 to extend outwardly, thereby providing elastic restoring force through the three elastic members 17. The aforementioned elastic mechanism including three elastic members 17 (coil springs) is an example only, and this disclosure is not limited thereto. In different embodiments, the number of the elastic members 17 (coil springs) may be less than or more than three.

The method for quick folding the trolley 1 of this embodiment will be described hereinafter with reference to FIGS. 1A to 1D in view of FIGS. 2A to 2F.

The folding method of the trolley 1 of this embodiment includes the following steps one to three.

As shown in FIGS. 2A and 2B, the step one is to release the handlebar bracket 19 and to fold the handlebar bracket 19 relative to the upper bracket 13 along a first direction D1, so that the handlebar bracket 19 is located at one side of the main bracket 11. In this embodiment, by loosening the adjusting member 191, the handlebar bracket 19 can be folded relative to the upper bracket 13 along the first direction D1, so that the handlebar bracket 19 can be located at the lower side of the main bracket 11. After the handlebar bracket 19 is substantially parallel to the main bracket 11, the adjusting member 191 can be fastened to fix the relative position of the handlebar bracket 19 and the main bracket 11. In the step one, other parts of the trolley 1 is not moved.

Afterwards, as shown in FIGS. 2C and 2D, the step two is to fold the upper bracket 13 relative to the main bracket 11 along a second direction D2, so that the first connecting rod(s) 15a can carry the sliding mechanism 14 to slide on the main bracket 11, and the second connecting rod(s) 15b, the third connecting rod(s) 15c and the fourth connecting rod(s) 15d can carry the rear wheel(s) 16 to move in the direction toward the connecting mechanism 12 (third direction D3) (i.e., the rear wheel(s) 16 is moved approaching and close to the first end E1 of the main bracket 11). As mentioned above, in this embodiment, since the two ends of each first connecting rod 15a are respectively connected to the sliding mechanism 14 and the upper bracket 13, one end of each second connecting rod 15b and one end of each third connecting rod 15c are respectively connected to the sliding mechanism 14, and the other end of each second connecting rod 15b and the other end of each third connecting rod 15c are respectively connected to each rear wheel 16. Therefore, when the sliding mechanism 14 slides on the main bracket 11, the two rear wheels 16 can be carried to move in the direction toward the first end E1 of the main bracket 11 (the third direction D3) and close to the first end E1 of the main bracket 11. In this case, the aforementioned parallel four-bar linkage structure is used to keep the plane defined by each rear wheel 16 to be parallel to the extension direction of the main bracket 11 during or after the folding process, thereby reducing the overall width of the folded trolley 1.

Finally, as shown in FIG. 2C to 2F, the step three is to continuously fold the upper bracket 13 relative to the main bracket 11 along the second direction D2 until the lower supporting frame 20b is fixed to the upper bracket 13. As shown in FIG. 2E, when the trolley 1 is in the folded state S2, the upper supporting frame 20a is located at two sides of the front wheel 18, and the lower supporting frame 20b can be fixed (engaged) to the upper bracket 13. In addition, the front wheel 18 and the two rear wheels 16 all face toward the same direction, which is substantially parallel to the extension direction of the main bracket 11. Specifically, when the trolley 1 is in the folded state S2, the plane defined by the front wheel 18 and the plane defined by each rear wheel 16 are substantially parallel to each other. In this case, the plane defined by the front wheel 18 refers to the plane defined by the frame of the front wheel, and the plane defined by the rear wheel 16 refers to the plane defined by the frame of the rear wheel.

With reference to FIG. 2F, when the trolley 1 is in the folded state S2, the two fourth connecting rods 15d are located at the lower side of the main bracket 11, and the main bracket 11 and the second connecting rods 15b are substantially parallel to each other. In addition, as shown in FIG. 3, when the trolley 1 is in the folded state S2, the overall width W of the trolley 1 of this embodiment is less than or equal to 3.5 times the width w of the front wheel 18 or the rear wheel 16 (W≤3.5 w).

As mentioned above, in the trolley 1 of this embodiment, since the fourth connecting rod 15d is configured with the bending portion 151, there will be no structural interference between the fourth connecting rod 15d and the connecting mechanism 12 when the sliding mechanism 14 slides on the main bracket 11 to make the second connecting rod 15b, the third connecting rod 15c and the fourth connecting rod 15b drive the rear wheel 16 to move in the direction toward the connecting mechanism 12. In addition, when the trolley 1 is in the folded state S2 (see FIGS. 2E and 3), the two rear wheels 16 can move toward the first end E1 of the main bracket 11 at the same time, thereby making the overall size of the folded trolley 1 smaller and thus reducing the amount of packaging volume. To be noted, the conventional trolleys of the same type usually have a packaging volume of at least 2.5 CBM/CUFT in the folded state, but the trolley 1 of this embodiment has a packaging volume of less than 1.7 CBM/CUFT in the folded state.

Moreover, as mentioned above, since the distance between the sliding mechanism 14 and the notch 153 of each second connecting rod 15b is less than the distance between the notch 153 and the rear wheel 16 (i.e., the notch 153 of each second connecting rod 15b is close to the connection of each third connecting rod 15c and the sliding mechanism 14), the structural interference between the second connecting rod 15b and the connection of the third connecting rod 15c and the sliding mechanism 14 in the folded state S2 can be avoided.

To be noted, the other technical features of the folding method of the trolley 1 of this embodiment can be referred to the above embodiment, so the detailed descriptions thereof will be omitted.

In the trolley 1 of this embodiment, the configuration of the bending portion 151 can prevent the mechanical interference between the fourth connecting rod 15d and the connecting mechanism, and the two rear wheels 16 can simultaneously face the extension direction of the main bracket 11 during the folded state S2, thereby making the folded trolley 1 (in the folded state S2) have a smaller size and thus reducing the amount of packaging volume. In addition, the configuration of the notch 153 on the second connecting rod 15b can prevent the structural interference between the second connecting rod 15b and the connection of the third connecting rod 15c and the sliding mechanism 14 during the folding process.

To be noted, in order to transform the trolley 1 of this embodiment from the folded state S2 to the operation state (unfolded state) S1, the unfolding process may the reverse steps of the above-mentioned steps one to three. Specifically, after applying a force to separate the upper bracket 13 from the lower supporting frame 20b (i.e., moving the upper bracket 13 in the direction opposite to the second direction D2), the elastic restoring force of the aforementioned elastic member 17 can be applied to push the extension portion 171 back into the elastic member 17. This step can also drive the sliding mechanism 14 to slide in the direction toward the first end E1 of the main bracket 11, and then carry the upper bracket 13 to move in the direction opposite to the second direction D2. At the same time, the second connecting rod(s) 15b, the third connecting rod(s) 15c, the fourth connecting rod(s) 15d and the rear wheel(s) 16 can be moved in the direction opposite to the third direction D3, so that the trolley 1 automatically returns to the state as shown in FIG. 2A. Afterwards, the adjusting member 191 is released, so that the handlebar bracket 19 moves relative to the upper bracket 13 in the direction opposite to the first direction D1. Then, after the handlebar bracket 19 returns to the position in the operation state (unfolded state) S1, the adjusting member 191 is fastened again. Finally, the trolley 1 in the operation state (unfolded state) S1 as shown in FIG. 1A can be presented, thereby achieving the rapid and easy unfolding process.

From the above-mentioned folding and unfolding processes, it can be understood that the trolley 1 of this embodiment can be transformed into the folded state S2 from the operation state (unfolded state) S1 by simple and quick folding steps, and is can also be transformed into the operation state (unfolded state) S1 from the folded state S2 automatically with the elastic restoring force provided by the elastic member 17. Therefore, in addition to the advantages of easy folding, unfolding and small operation force, the trolley 1 of this embodiment further has a relatively small overall size after folding, which can reduce the amount of packaging volume.

In summary, in the trolley and the folding method thereof of this disclosure, the sliding mechanism is slidably arranged on the main bracket, two ends of the first connecting rod are respectively connected to the sliding mechanism and the upper bracket, the second connecting rod is disposed parallel to the third connecting rod, one end of the second connecting rod and one end of the third connecting rod are respectively connected to the sliding mechanism, the other end of the second connecting rod and the other end of the third connecting rod are respectively connected to the rear wheel, the third end of the fourth connecting rod is connected to the second connecting rod and is located between the sliding mechanism and the rear wheel, and the fourth end of the fourth connecting rod is connected to the connecting mechanism. Based on the structural design of this disclosure, when the sliding mechanism slides on the main bracket so as to carry the second connecting rod, the third connecting rod and the fourth connecting rod to move the rear wheel toward the connecting mechanism, there will be no structural interference between the fourth connecting rod and the connecting mechanism. In addition, when the trolley is in the folded state, the rear wheel can be moved toward and close to the first end of the main bracket. Accordingly, the trolley of this disclosure can simplify the folding process thereof, and reduce the size thereof in the folded state so as to decrease the amount of packaging volume.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A trolley, comprising:
a main bracket having a first end and a second end;
a connecting mechanism arranged at the first end of the main bracket;
an upper bracket connected to the first end of the main bracket through the connecting mechanism;
a sliding mechanism slidably arranged on the main bracket;
at least one first connecting rod, wherein two ends of the first connecting rod are respectively connected to the sliding mechanism and the upper bracket;
at least one second connecting rod;
at least one third connecting rod;
at least one rear wheel, wherein the second connecting rod is disposed parallel to the third connecting rod, one end of the second connecting rod and one end of the third connecting rod are respectively connected to the sliding mechanism, and the other end of the second connecting rod and the other end of the third connecting rod are respectively connected to the rear wheel; and
at least one fourth connecting rod having a third end, a fourth end and a bending portion, wherein the third end of the fourth connecting rod is connected to the second connecting rod and is located between the sliding mechanism and the rear wheel, the fourth end of the fourth connecting rod is connected to the connecting mechanism, and the bending portion is arranged at a middle section of the fourth connecting rod.

2. The trolley of claim 1, wherein the second connecting rod comprises a protruding portion, and the third end of the fourth connecting rod is connected to the protruding portion of the second connecting rod.

3. The trolley of claim 1, further comprising:
an elastic mechanism arranged inside the main bracket and connected to the sliding mechanism.

4. The trolley of claim 3, wherein the elastic mechanism comprises at least one elastic member, the elastic member has an extension portion, and the extension portion is connected to the sliding mechanism.

5. The trolley of claim 4, wherein when the sliding mechanism slides on the main bracket, the extension portion moves along with the sliding mechanism.

6. The trolley of claim 1, wherein the second connecting rod has a notch, and a distance between the notch and the sliding mechanism is less than a distance between the notch and the rear wheel.

7. The trolley of claim 1, wherein a distance between the bending portion and the fourth end is less than a distance between the bending portion and the third end.

8. The trolley of claim 1, further comprising:
a front wheel arranged at the second end of the main bracket;
wherein, when the trolley is in a folded state, the front wheel and the rear wheel face toward one direction, and the direction is parallel to an extending direction of the main bracket.

9. The trolley of claim 8, wherein when the trolley is in the folded state, the main bracket is parallel to the second connecting rod.

10. The trolley of claim 8, wherein when the trolley is in the folded state, an overall width of the trolley is less than or equal to 3.5 times of a width of the front wheel or the rear wheel.

11. The trolley of claim 8, further comprising:
a handlebar bracket connected to one end of the upper bracket away from the main bracket;
an upper supporting frame arranged at one side of the upper bracket away from the main bracket; and
a lower supporting frame arranged at the second end of the main bracket.

12. The trolley of claim 11, wherein when the trolley is in the folded state, the upper supporting frame is located at two sides of the front wheel, and the lower supporting frame is fixed on the upper bracket.

13. A folding method of a trolley, wherein the trolley comprises a main bracket, a connecting mechanism, an upper bracket, a sliding mechanism, at least one first connecting rod, at least one second connecting rod, at least one third connecting rod, at least one rear wheel, at least one fourth connecting rod, a handlebar bracket, and a lower supporting frame, the main bracket has a first end and a second end, the connecting mechanism is arranged at the first end of the main bracket, the upper bracket is connected to the first end of the main bracket through the connecting mechanism, the sliding mechanism is slidably arranged on the main bracket; two ends of the first connecting rod are respectively connected to the sliding mechanism and the upper bracket, the second connecting rod is disposed parallel to the third connecting rod, one end of the second connecting rod and one end of the third connecting rod are respectively connected to the sliding mechanism, the other end of the second connecting rod and the other end of the third connecting rod are respectively connected to the rear wheel, the fourth connecting rod has a third end, a fourth end and a bending portion, the third end of the fourth connecting rod is connected to the second connecting rod and is located between the sliding mechanism and the rear wheel, the fourth end of the fourth connecting rod is connected to the connecting mechanism, and the bending portion is arranged at a middle section of the fourth connecting rod, the handlebar bracket is connected to one end of the upper bracket away from the main bracket, and the lower supporting frame is arranged at the second end of the main bracket, the folding method comprising:
releasing the handlebar bracket and folding the handlebar bracket relative to the upper bracket along a first direction, so that the handlebar bracket is located at one side of the main bracket;
folding the upper bracket relative to the main bracket along a second direction, so that the first connecting rod carries to the sliding mechanism to slide on the main bracket, and then the second connecting rod, the third connecting rod and the fourth connecting rod carries the rear wheel to move toward the connecting mechanism; and
continuously folding the upper bracket relative to the main bracket along the second direction until the lower supporting frame is fixed to the upper bracket.

14. The folding method of claim 13, wherein the second connecting rod comprises a protruding portion, and the third end of the fourth connecting rod is connected to the protruding portion of the second connecting rod.

15. The folding method of claim 13, wherein the trolley further comprises an elastic mechanism arranged inside the main bracket and connected to the sliding mechanism.

16. The folding method of claim 15, wherein the elastic mechanism comprises at least one elastic member, the elastic member has an extension portion, and the extension portion is connected to the sliding mechanism.

17. The folding method of claim 16, wherein when the sliding mechanism slides on the main bracket, the extension portion moves along with the sliding mechanism.

18. The folding method of claim 13, wherein the second connecting rod has a notch, and a distance between the notch and the sliding mechanism is less than a distance between the notch and the rear wheel.

19. The folding method of claim 13, wherein the trolley further comprises a front wheel arranged at the second end of the main bracket;
wherein, when the trolley is in a folded state, the front wheel and the rear wheel face toward one direction, and the direction is parallel to an extending direction of the main bracket.

20. The folding method of claim 19, wherein when the trolley is in the folded state, the main bracket is parallel to the second connecting rod.
